(19) United States
(12) Patent Application Publication
(10) Pub. No.: US 2021/0196024 A1
(43) Pub. Date: Jul. 1, 2021

(54) Adhesive for nail art and nail art

(71) Applicant: GlluGa Inc., Cheonan-si (KR)

(72) Inventor: Jun Gil UM, Hwaseong-si (KR)

(21) Appl. No.: 17/134,987

(22) Filed: Dec. 28, 2020

(30) Foreign Application Priority Data
Dec. 27, 2019 (KR) 10-2019-0176030
Dec. 28, 2020 (KR) 10-2020-0184805

(51) Int. Cl. A45D 29/00; C09J 101/18; C09J 133/08

(52) U.S. Cl. CPC A45D 29/001; C09J 133/08; C09J 101/18

(57) ABSTRACT

An adhesive for a nail art includes: a UV-curable raw material, a photoinitiator, and a resin, wherein 6 wt % to 30 wt % of the UV-curable raw material, 1 wt % to 10 wt % of the photoinitiator, and 65 wt % to 85 wt % of the resin are included in the adhesive for a nail art.

### CROSS-REFERENCE TO RELATED APPLICATION

This application claims the benefit of priority to Korean Patent Application Nos. 10-2019-0176030 and 10-2020-0184805, filed in the Korean Intellectual Property Office on Dec. 27, 2019 and Dec. 28, 2020, respectively, the entire contents of which are incorporated herein by reference.

### TECHNICAL FIELD

### Technical Field

The present disclosure relates to an adhesive for a nail art including a UV-curable raw material, a photoinitiator, and a resin.

### Background

The beauty industry has been acceleratedly developed and subdivided simultaneously, as one way of expression of physical beauty pursued by humans. In particular, the beauty industry began to be popularized among ordinary people together with rapid market expansion after the 20th century. In the beauty industry, nail art has been recently rapidly developed as an essential element of expression arts for the body regardless age group and gender.

Originally, nail art is one of the ways for beautifully decorating the human body as a field of beauty arts, and the length, shape, or color of a nail has been expressed by reflecting changes and values of the culture of the times.

Among the nail arts, a nail art in an artificially manufactured nail or toenail shape is used by many people. In the past, the nail art was manufactured in a curved shape like a nail or toenail shape and supplied to consumers. However, since each person has different nail or toenail shape (in particular a curvature radius), it was difficult to closely adhere a nail art having an already curved shape to a nail or toenail of a consumer.

As a method of solving the problem, a nail art including a UV-curable resin has been recently spotlighted. Specifically, a nail art including the UV-curable resin is supplied to consumers with the lower surface being flat, and the consumers deform the nail art to fit their nail or toenail and then irradiate UV thereon to cure the nail art. Accordingly, the nail art is closely adhered to the consumers' nail or toenail, thereby improving adhesive strength of the nail art.

Meanwhile, in order to maximize aesthetics of the nail art, sometimes, a decoration (also called part) is attached on the nail art. The decorations are attached to the nail art by an adhesive. However, when the decorations are attached to the nail art including the UV-curable resin by a conventional adhesive, the following problems arise. Specifically, even in the case in which consumers forcibly deform the nail art (deform the nail art to have a predetermined curvature to fit their nail or toenail), when the force is removed, the nail art easily returns to a flat form by high elasticity of the conventional adhesive. In addition, even in the case in which the nail art is cured by proceeding with UV curing with difficulty, the nail art tends to return to a flat form by the elasticity of the adhesive, and thus, the nail art is easily detached from a nail or toenail.

Therefore, an adhesive for a nail art for solving the problems is demanded.

### DISCLOSURE

### Technical Problem

An aspect of the present disclosure provides an adhesive for a nail art which may minimize a phenomenon that the nail art returns to a shape before deformation in a process in which consumers forcibly deform a nail art to fit a shape of their nail or toenail, and may suppress a phenomenon that the nail art returns to a shape before deformation by curing after UV irradiation.

Another aspect of the present disclosure provides a nail art including the adhesive for a nail art.

### Technical Solution

According to an aspect of the present disclosure, an adhesive for a nail art includes: a UV-curable raw material, a photoinitiator, and a resin, wherein 6 wt % to 30 wt % of the UV-curable raw material, 1 wt % to 10 wt % of the photoinitiator, and 65 wt % to 85 wt % of the resin are included in the adhesive for a nail art.

According to another aspect of the present disclosure, an adhesive for a nail art includes: a UV-curable raw material, a photoinitiator, and a resin, wherein a loss modulus (G″) measured under a condition of 22° C., 10 rad/s, and a 10% strain is 150 Pa to 2,500 Pa.

According to still another aspect of the present disclosure, a nail art includes: a coating layer; the adhesive for a nail art disposed on the coating layer; and a decoration disposed on the adhesive.

### Effects of Invention

The adhesive for a nail art according to the present disclosure may minimize a phenomenon that the nail art returns to a shape before deformation in a process in which consumers forcibly deform a nail art to fit a shape of their nail or toenail, and may suppress a phenomenon that the nail art returns to a shape before deformation by curing after UV irradiation. Accordingly, close adhesion between the nail art and a nail (or toenail) is improved to improve nail art adhesive strength. In addition, in the nail art, the adhesive for a nail art may cover at least a portion of a side surface of a decoration, and in the case of an adhesive for a nail art including a UV-curable raw material, a thickness of the adhesive for a nail art covering the side surface of the decoration may be in an appropriate level, thereby minimizing occurrence of cracks in the adhesive for a nail art covering the side surface of the decoration, and thus, the decoration may be effectively attached and fixed.

### BRIEF DESCRIPTION OF THE DRAWINGS

FIG. 1 is a schematic plan view of an adhesive for a nail art according to an exemplary embodiment of the present disclosure;

FIG. 2 is a schematic cross-sectional view of an adhesive for a nail art corresponding to a line A-A′ of FIG. 1;

FIGS. 3 and 4 are schematic plan views describing a nail art according to an exemplary embodiment of the present invention;

FIG. 5 is a schematic cross-sectional view of a nail art corresponding to a line B-B′ of FIG. 4; and

FIG. 6 is a schematic cross-sectional view of a state that the nail art of the present disclosure is deformed (curved).

### DETAILED DESCRIPTION

Since the present disclosure may be variously modified and have several exemplary embodiments, specific exemplary embodiments will be shown in the accompanying drawings and be described in detail in a detailed description.

However, it is to be understood that the present disclosure is not limited to a specific exemplary embodiment, but includes all modifications, equivalents, and substitutions without departing from the scope and spirit of the present disclosure. When it is determined that the detailed description of the known art related to the present disclosure may obscure the gist of the present disclosure, the detailed description thereof will be omitted.

Terms used in the present specification are used only in order to describe specific exemplary embodiments rather than limiting the present disclosure. Singular forms are intended to include plural forms unless otherwise indicated contextually.

It will be further understood that in the present disclosure, the term such as “comprises” or “have” specifies the presence of stated features, numerals, steps, operations, constituent elements, parts, or a combination thereof, but does not preclude the presence or addition of one or more other features, numerals, steps, operations, constituent elements, parts, or a combination thereof.

In the present disclosure, being disposed or positioned “on” a subject may mean not only being present on the subject in a directly abutting state but also being disposed or positioned on the subject in a spaced state.

In the present disclosure, a loss modulus and a viscosity may be measured by Frequency sweep available from Rheologies.

In the present disclosure, a tensile strength may be measured by UNITEST1 available from TESTONE Co., Ltd.

<Adhesive for Nail Art>

An adhesive for a nail art refers to an adhesive for attaching a decoration on a coating layer of a nail art, and the nail art refers to a laminate disposed on a nail or toenail. The nail art has the same meaning as a nail sticker.

The adhesive for a nail art according to an exemplary embodiment of the present disclosure includes: a UV-curable raw material, a photoinitiator, and a resin, wherein 6 wt % to 30 wt % of the UV-curable raw material, 1 wt % to 10 wt % of the photoinitiator, and 65 wt % to 85 wt % of the resin for a nail art may be included in the adhesive for a nail art.

UV-Curable Raw Material

The UV-curable raw material serves to cure the adhesive for a nail art while a shape of the adhesive for a nail art at the time of irradiation is maintained, when irradiating the adhesive for a nail art with ultraviolet rays.

The UV-curable raw material may include at least any one selected from the group consisting of urethane acrylate-based oligomers, polyester acrylate-based oligomers, acryl acrylate-based oligomers, and epoxy acrylate-based oligomers. The polyester acrylate-based oligomer may be an unsaturated polyester acrylate-based oligomer.

In particular, the UV-curable raw material may include a urethane acrylate-based oligomer. When the UV-curable raw material includes the urethane acrylate-based oligomer, a haze phenomenon may not occur to maintain transparency of the adhesive for a nail art.

The urethane acrylate-based oligomer may include di- or higher functional urethane acrylate-based oligomer. In particular, the urethane acrylate-based oligomer may include at least any one of hexafunctional urethane acrylate-based oligomers and nonafunctional urethane acrylate-based oligomers. When the hexafunctional urethane acrylate-based oligomer or the nonafunctional urethane acrylate-based oligomer is included in the UV-curable raw material, adhesive strength of the adhesive for nail art may be maintained at an appropriate level.

Specifically, the urethane acrylate-based oligomer may include at least any one selected from PU210, Pu 280, PU640, and SC2404 available from Miwon Specialty Chemical Co., Ltd., and CN 9033 and CN 9047 available from SARTOMER.

The urethane acrylate-based oligomer may have a weight average molecular weight of 1,000 g/mol to 100,000 g/mol, specifically 1,000 g/mol to 25,000 g/mol. When the range is satisfied, viscosity is low so that it is easy to work with.

The UV-curable raw material may be included at 6 wt % to 30 wt %, specifically 15 wt % to 20 wt % in the adhesive. When the range is satisfied, the adhesive is flexible so that it is easy to attach decorations.

Photoinitiator

The photoinitiator serves to initiate a polymerization reaction by UV irradiation. Specifically, the photoinitiator may be a UV photoinitiator.

The photoinitiator may include at least any one selected from the group consisting of trimethylbenzoyl phosphine oxide, phenylbis(2,4,6-trimethylbenzoyl)phosphine oxide, and 2-benzyl-2-(dimethylamino)-1-[4-(4-morpholinyl)phenyl]-1-butanone, but is not necessarily limited thereto.

The photoinitiator may be included at 1 wt % to 10 wt %, specifically 2 wt % to 5 wt % in the adhesive. When the range is satisfied, the adhesive is stable in the surrounding environment, and may be sufficiently cured upon UV irradiation.

Resin

The resin may serve to maintain the form by controlling the flowability of the adhesive for a nail art. In addition, since the adhesive for a nail art may have an appropriate viscosity by the resin, the decoration may be fixed well on the nail art.

The resin may be a thermoplastic resin having a glass transition temperature (T_{g}) of 50° C. to 110° C., specifically 50° C. to 80° C. In this case, the adhesive has a high flexibility to be advantageous for a process.

The resin may have a weight average molecular weight of 10,000 g/mol to 100,000 g/mol, specifically 30,000 g/mol to 80,000 g/mol. When the range is satisfied, flexibility of the adhesive is high, and thus, close adhesion of the adhesive to decorations is excellent so that the decorations may be effectively attached and fixed.

The resin may include at least any one selected from the group consisting of acryl-based resins, nitrocellulose resins, polyvinyl resins, urethane resins, and vinylacetate resins.

In particular, the resin may include an acryl-based resin and a nitrocellulose resin. When the resin includes an acryl-based resin, adhesive strength to decorations is excellent. When the resin includes a nitrocellulose resin, the adhesive may have high gloss strength to increase gloss of the nail art.

The acryl-based resin may have a weight average molecular weight of 30,000 g/mol to 80,000 g/mol. The nitrocellulose resin may include at least any one selected from the group consisting of ⅛ seconds, ¼ seconds, ½ seconds, and 20 seconds. Among them, ½-second nitrocellulose resin is preferred in terms of flowability and gloss characteristics.

The resin may be included at 65 wt % to 85 wt %, specifically 67 wt % to 83 wt % in the adhesive. When the range is satisfied, a thick film may be formed after drying to improve fixing force.

A weight ratio of the UV-curable raw material and the resin may be 6:94 to 30:70, specifically 15:85 to 20:80. When the range is satisfied, adhesive strength and processability may be improved.

The nail art may include a solvent. The solvent corresponds to a solvent used when a composition for preparing the adhesive for a nail art is formed, and is removed by drying in a process of preparing the adhesive for a nail art. However, some solvents may necessarily remain at a very low content in the adhesive for a nail art.

The nail art according to another exemplary embodiment of the present disclosure includes a UV-curable raw material, a photoinitiator, and a resin, wherein a loss modulus (G″) measured under a condition of 22° C., 10 rad/s, and a 10% strain may be 150 Pa to 2,500 Pa. Here, since the UV-curable raw material, the photoinitiator, and the resin are the same as those of the exemplary embodiment described above, descriptions thereof will be omitted. In addition, the nail art may be the same as the nail art of the exemplary embodiment described above.

In the adhesive for a nail art, the loss modulus (G″) measured under a condition of 22° C., 10 rad/s, and a 10% strain may be 150 Pa to 2,500 Pa, specifically 150 Pa to 1,600 Pa. When the loss modulus is less than 150 Pa, a viscous property of the adhesive for a nail art is low, so that the nail art in which the adhesive for a nail art should maintain its deformation highly tends to return to the original shape by the high elasticity. Accordingly, it is difficult for the nail art to be deformed in a state of being closely adhered to a nail or toenail and maintained, which thus causes discomfort during its wearing and a difficulty in close adhesion, thereby deteriorating nail art adhesive strength. On the contrary, when the loss modulus is more than 2,500 Pa, the viscous property is excessively high, so that the adhesive cracks or is broken even at a low stress.

In the adhesive for a nail art, the viscosity of the adhesive for a nail art measured under a condition of 22° C., 10 rad/s, and a 10% strain may be 50 Pa·s to 100 Pa·s, specifically 60 Pa·s to 100 Pa·s. When the range is satisfied, the adhesive for a nail art may be present in a state of covering at least a portion of a side surface of a decoration, and thus, the fixing force of the decoration may be improved.

The adhesive for a nail art has a flexible physical property before being cured by UV irradiation, but has a hard physical property in a solid state when curing is completed by UV irradiation. The adhesive for a nail art may be a semi-curable adhesive, by this characteristic.

The adhesive for a nail art may have an elastic modulus of 20 kgf/mm² to 120 kgf/mm², as measured after UV-cured by UV irradiation. When the range is satisfied, the decoration may be firmly fixed to the adhesive for a nail art, and even in the case in which a user deforms the nail art to be bent, the decoration may be firmly attached to the nail art.

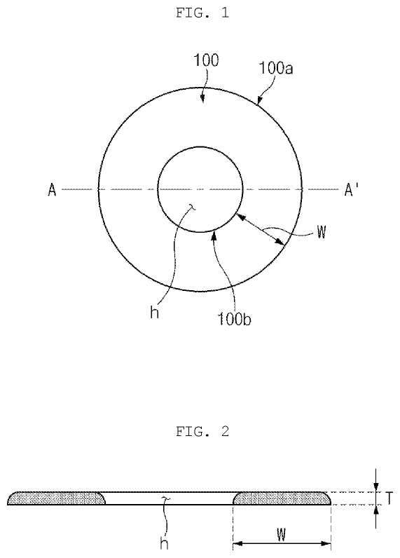

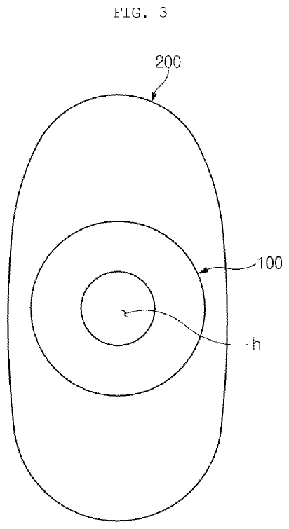

FIG. 1 is a schematic plan view of the adhesive for a nail art according to the above exemplary embodiments, and FIG. 2 is a schematic cross-sectional view of the adhesive for a nail art corresponding to line A-A′ of FIG. 1.

Referring to FIGS. 1 and 2, the adhesive for a nail art 100 may be in the form of having an outer periphery 100a and an inner periphery 100b spaced apart from the outer periphery 100a. Simply put, this may be in the form of a donut. However, the shapes of the outer periphery 100a and the inner periphery 100b are not necessarily limited to a circle, and may be angular. In addition, the shapes of the outer periphery 100a and the inner periphery 100b may not be similar to each other.

A width (W) of the adhesive for a nail art 100 may be 1 mm to 4 mm, specifically 2 mm to 2.5 mm. The width means a distance between the outer periphery 100a and the inner periphery 100b. When the range is satisfied, a part of the adhesive for a nail art 100 may easily cover the side surface of the decoration 300, and a contact area of the lower surface of the decoration 300 and the adhesive for a nail art 100 may be maintained at an appropriate level, and thus, the decoration may be firmly fixed. A thickness (T) of the adhesive for a nail art 100 may be 500 μm to 5,000 μm, specifically 1,500 μm to 4,000 μm. When the range is satisfied, sufficient adhesive strength may be expressed.

Continuously, referring to FIGS. 1 and 2, the adhesive for a nail art includes a hole (h). The hole (h) corresponds to a donut hole in a donut form. The hole (h) corresponds to the inside of the inner periphery 100b, and penetrates the adhesive for a nail art. The hole (h) is positioned under the decoration. When the adhesive for a nail art does not a hole and the lower surface of the decoration is all adhered to the adhesive for a nail art, the adhesive strength between the decoration and the adhesive for a nail art is weaken by an “uncured UV-curable raw material” and/or an unintentional “residual solvent” present in the adhesive for a nail art which is not exposed to the outside by the decoration. Therefore, the inside of the lower surface of the decoration covers the hole of the adhesive for a nail art, thereby maintaining the adhesive strength between the decoration and the adhesive for a nail art.

Nail Art>

The nail art according to another exemplary embodiment of the present disclosure may include a coating layer; an adhesive for nail art disposed on the coating layer; and a decoration disposed on the adhesive. Since the adhesive for a nail art is the same as the adhesives for a nail art of the exemplary embodiments described above, descriptions thereof will be omitted.

The coating layer may include a UV-curable resin. Since the coating layer includes the UV-curable resin, consumers who purchased the nail art may deform the nail art so to be closely adhered to their nail or toenail, and then irradiate UV to cure the nail art to fix the deformed nail art.

Referring to FIG. 5, the lower surface of the nail art may be flat due to such usage. Herein, the word “flat” means that the nail art is not manufactured to have a curvature in a similar level to the curvature of a nail or toenail, but formed to have a lower surface in or close to a horizontal level. Since the nail art has flexible physical properties, consumers acquire the nail art and deform (like bending) the nail art to fit their nail or toenail, thereby closely adhering the nail art to their nail or toenail. Accordingly, the lower surface of the nail art (a portion in contact with a nail or toenail) may include a flat portion, and specifically, may be flat. Meanwhile, the lower surface 200a of the coating layer may also be flat.

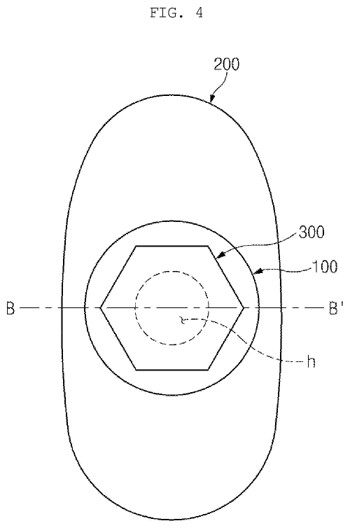

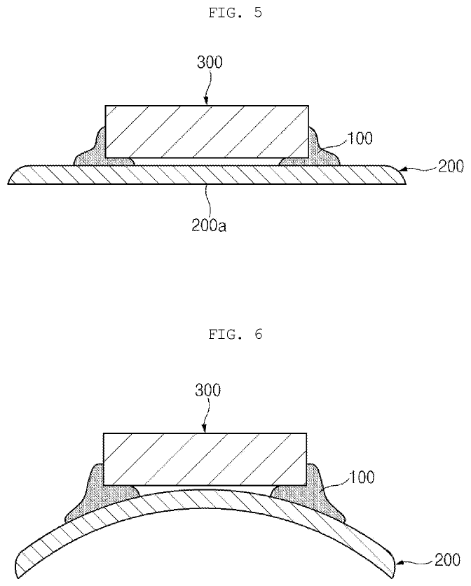

Referring to FIGS. 3 and 4, the adhesive for a nail art 100 may be disposed on the coating layer 200. However, being “on the coating layer 200” does not mean only being positioned just on the coating layer 200 so as to be in contact with the coating layer, but also includes a case in which a separate layer is present on the coating layer 200 and the adhesive for a nail art 100 is positioned on the separate layer so as to be in contact with the separate layer.

The decoration 300 is also recognized as a word “part” in the art. The decoration 300 is not limited to a specific shape. The decoration may include at least any one of various materials such as metal or plastic. The decoration 300 may be disposed on the adhesive for a nail art 100. A part of the adhesive for a nail art 100 may climb on the side surface of the decoration 300 and cover at least a part of the side surface of the decoration 300. Accordingly, the decoration may be firmly attached by the adhesive for a nail art 100.

Like the exemplary embodiment described above, the adhesive for a nail art 100 may be in the form of having an outer periphery and an inner periphery spaced apart from the outer periphery, and the inside of the inner periphery may correspond to a hole (h) penetrating the adhesive for a nail art. Here, the decoration may be disposed on the adhesive for a nail art 100 while covering the hole h. Specifically, the inside of the lower surface of the decoration 300 covers the hole of the adhesive for a nail art, thereby maintaining the adhesive strength between the decoration 300 and the adhesive for a nail art 100.

The nail art may further include a substrate layer (not shown). The coating layer may be disposed on the substrate layer. The substrate layer may include an adhesive layer, and the adhesive layer may form a lower surface of the nail art. The adhesive layer may include an adhesive component commonly used in the art.

The substrate layer may include a design layer positioned between the adhesive layer and the coating layer. The design layer may include at least any one of a color layer including a pigment and a printed layer expressing a pattern.

Hereinafter, preferred examples will be provided in order to assist in the understanding of the present disclosure, but it will be obvious that the following examples are only illustrative of the present disclosure, and various modifications and alterations may be made within the scope and technical idea of the present disclosure, and also it will be natural that these modifications and alterations may fall within the scope of the appended claims, to those skilled in the art.

### EXAMPLES AND COMPARATIVE EXAMPLES

### Example 1: Manufacture of Adhesive for Nail Art

Hexafunctional urethane acrylate as a UV-curable raw material, trimethylbenzoyl phosphine oxide as a photoinitiator, and an acryl resin and a nitrocellulose resin as a resin were mixed with a dibasic ester as a solvent and stirring was performed to form an adhesive forming composition.

The adhesive forming composition was formed into a donut shape by a screen printing method, and dried at 80° C. for 30 minutes to prepare an adhesive for a nail art. In the adhesive for a nail art, a weight ratio of the UV-curable raw material, the photoinitiator, and the resin was 18:2:80.

### Comparative Example 1: Preparation of Adhesive for Nail Art

An adhesive available from Loctite (model name: 404) was prepared, and an adhesive having the same shape as the adhesive for a nail art of Example 1 was prepared. The adhesive did not include the UV-curable raw material.

### Experimental Example

### Experimental Example 1: Rheometer Analysis (Evaluation of Viscous Property, Elasticity, and Viscosity)

The viscous property, elasticity, and viscosity of each of the adhesives of Example 1 and Comparative Example 1 were evaluated by a rheometer available from Rheologies (model name: Frequency Sweep).

A storage modulus (G′), a loss modulus (G″), and a viscosity of the adhesives of Example 1 and Comparative Example 1 when temperature: 22° C., a distance between an upper plate and a lower plate: 1.0 mm, strain: 10.0%, and an angular speed: 10 rad/sec, are shown in the following Table 1.

### Experimental Example 2: Evaluation of Elastic Modulus after UV Curing

The elastic modulus of each of the adhesives of Example 1 and Comparative Example 1 was evaluated by UNITEST1 available from Test One, and is shown in Table 1.

Specifically, each adhesive was irradiated with UV under a condition of irradiation with a light source of 6 W for 30 seconds, and then the elastic modulus was evaluated.

TABLE 1

| | Storage | Loss | | Elastic |
|---|---|---|---|---|
| | modulus | modulus | Viscosity | modulus |
| | (G′) (Pa) | (G″) (Pa) | (Pa · s) | (kgf/mm²) |
| Example 1 | 280 | 780 | 82 | 80 |
| Comparative | 1,000 | 120 | 10 | 120 |
| Example 1 | | | | |

### Experimental Example 3: Evaluation of Attachment Degree of Decoration and Evaluation of Restoration Degree of Nail Art after UV Irradiation

(1) Manufacture of Nail Art

A laminate including a UV-curable resin and a coating layer including the resin was prepared. The adhesive prepared in Example 1 or Comparative Example 1 was disposed on the coating layer, and then a decoration was disposed on the adhesive to manufacture a nail art. The lower surface of the nail art was flat.

(2) Nail Art Wearing

The lower surface of the nail art was disposed on the curved nail model so that the lower surface faced the nail model, and then the nail art was deformed so as to be completely closely adhered to the curved nail model. Thereafter, the coating layer of the nail art was cured under a condition of UV of 6 W for 30 seconds, and the adhesive for a nail art of Example 1 was also cured.

In this process, the nail art of Comparative Example 1 was not easily deformed. This is because the adhesive of Comparative Example 1 has a low loss modulus and a very high storage modulus to prevent deformation of the nail art. When it was forcibly deformed by more power, the adhesive surrounding the decoration had cracks.

(3) Evaluation of Attachment Degree of Decoration

The evaluation was performed by a method of forcibly separating the decoration using a push-full gauge.

(4) Evaluation of Restoration Degree of Nail Art

The nail art in which the adhesive of Example 1 was used was separated from the nail model, and then it was observed over time whether the nail art was flat again.

TABLE 2

| | Evaluation of | Evaluation of |
|---|---|---|
| | attachment | restoration degree of |
| | degree of decoration | nail art |
| Example 1 | 50 kgf or more | Bent nail art did not become flat. |
| Comparative | 30 kgf | (It was impossible to perform |
| Example 1 | | evaluation since it was difficult to |
| | | deform the nail art.) |

### DESCRIPTION OF SYMBOLS

100: adhesive for a nail art
100a: outer periphery
100b: inner periphery
h: hole
200: coating layer
200a: lower surface of coating layer
300: decoration

1. An adhesive for a nail art comprising: a UV-curable raw material, a photoinitiator, and a resin,
wherein 6 wt % to 30 wt % of the UV-curable raw material, 1 wt % to 10 wt % of the photoinitiator, and 65 wt % to 85 wt % of the resin are included in the adhesive for a nail art.

2. The adhesive for a nail art of claim 1, wherein the UV-curable raw material includes at least any one selected from the group consisting of urethane acrylate-based oligomers, polyester acrylate-based oligomers, acryl acrylate-based oligomers, and epoxy acrylate-based oligomers.

3. The adhesive for a nail art of claim 1, wherein the UV-curable raw material includes a urethane acrylate-based oligomer.

4. The adhesive for a nail art of claim 3, wherein the urethane acrylate-based oligomer includes at least any one of hexafunctional urethane acrylate-based oligomers and nonafunctional urethane acrylate-based oligomers.

5. The adhesive for a nail art of claim 1, wherein the photoinitiator includes at least any one selected from the group consisting of trimethylbenzoyl phosphine oxide, phenylbis(2,4,6-trimethylbenzoyl)phosphine oxide, and 2-benzyl-2-(dimethylamino)-1-[4-(4-morpholinyl)phenyl]-1-butanone.

6. The adhesive for a nail art of claim 1, wherein the resin is a thermoplastic resin having a glass transition temperature (T_{g}) of 50° C. to 110° C.

7. The adhesive for a nail art of claim 1, wherein the resin includes at least any one selected from the group consisting of acryl-based resins, nitrocellulose resins, polyvinyl resins, urethane resins, and vinylacetate resins.

8. The adhesive for a nail art of claim 1, wherein the adhesive is in a form having an outer periphery and an inner periphery spaced apart from the outer periphery, and an inside of the inner periphery corresponds to a hole penetrating the adhesive for a nail art.

9. An adhesive for a nail art comprising: a UV-curable raw material, a photoinitiator, and a resin,
wherein a loss modulus (G″) measured under a condition of 22° C., 10 rad/s, and a 10% strain is 150 Pa to 2,500 Pa.

10. The adhesive for a nail art of claim 1, wherein a viscosity of the adhesive for a nail art measured under a condition of 22° C., 10 rad/s, and a 10% strain is 50 Pa·s to 100 Pa·s.

11. The adhesive for a nail art of claim 1, wherein an elastic modulus measured after UV curing is 20 kgf/mm² to 120 kgf/mm².

12. A nail art comprising:
a coating layer;
the adhesive for a nail art of claim 1 disposed on the coating layer; and
a decoration disposed on the adhesive.

13. The nail art of claim 12, wherein the coating layer includes a UV-curable resin.

14. The nail art of claim 12, wherein a lower surface of the nail art is flat.

15. The nail art of claim 12,
wherein the adhesive for a nail art is in a form of having an outer periphery and an inner periphery spaced apart from the outer periphery,
an inside of the inner periphery corresponds to a hole penetrating the adhesive for a nail art, and
the decoration covers the hole and is disposed on the adhesive for a nail art.

16. The nail art of claim 12, wherein a part of the adhesive covers at least a part of a side surface of the decoration.
